(19) United States
(12) Patent Application Publication
(10) Pub. No.: US 2025/0172420 A1
(43) Pub. Date: May 29, 2025

(54) PIPELINE INSERTION DEVICE

(71) Applicant: BOHR LIMITED, STONE, STAFFORDSHIRE (GB)

(72) Inventors: Jack EDWARD KNIGHT, Shrewsbury, Shropshire (GB); Jeremy KNIGHT, Shrewsbury, Shropshire (GB)

(21) Appl. No.: 18/730,435

(22) PCT Filed: Jan. 19, 2023
(86) PCT No.: PCT/GB2023/050093

§ 371 Date: Jul. 19, 2024

(30) Foreign Application Priority Data
Jan. 20, 2022 (GB) 2200740.5
Feb. 1, 2022 (GB) 2201266.0

(51) Int. Cl. G01F 1/46; G01K 13/02; G01N 1/10; G01N 1/20

(52) U.S. Cl. CPC G01F 1/46; G01K 13/026; G01N 1/2035; G01N 2001/1031; G01N 2001/2064

(57) ABSTRACT

A pipeline insertion device is disclosed which is suitable for in-line flow rate measurement of a fluid in a pipeline, and which comprises an elongate device body having an outer surface comprising an in-use upstream portion and an in-use downstream portion. There is also a plurality of fluid-flow-directing elements positioned on the outer surface of the elongate device body, the plurality of fluid-flow-directing elements being perimetrically offset to both the upstream portion and the downstream portion of the elongate device body.

### RELATED APPLICATIONS

This application is based on prior filed copending International Application No. PCT/GB2023/050093 filed Jan. 19, 2023, which claims priority to Great Britain Application No. 2200740.5, filed Jan. 20, 2022 and Great Britain Application No. 2201266.0, filed Feb. 1, 2022, the entire subject matter of these applications is incorporated herein by reference in its entirety.

### TECHNICAL FIELD

The present invention relates to a pipeline insertion device, such as a pitot tube, preferably but not exclusively for in-line flow measurement of a fluid in a pipeline. Said device can be utilised in other applications, in particular, for sampling of said fluid, and/or for measuring other characteristics, such as temperature, by reconfiguration of the associated apparatus. The invention further relates to a similar sampling probe device, as well as to a generalised measurement probe device, as well as to a combined pitot tube and sampling probe device. Sample injection type devices may also utilise this technology.

### BACKGROUND

A pitot tube is a device designed to measure flow in fluid, in order to calculate the fluid flow velocity, and can be used for determination of flow characteristics in natural gas pipelines, for example, but is generally applicable in liquid, gas, and steam flow measurement applications across different industries, including oil production and refinement, water treatment and distribution, gas processing and transmission, and in the chemical and petrochemical sectors.

An opening of the pitot tube points directly into the fluid flow, and the pressure of the fluid plus a dynamic pressure itself can thus be measured as the moving fluid is brought to rest in the pitot tube itself in the absence of a fluid outlet.

For pipeline analysis, the pitot tube is provided in an elongate probe body, having openings which are positioned on an in-use flow upstream face thereof, as well as an in-use flow downstream face thereof. The differential pressure can therefore be determined by comparison of the readings of the upstream and downstream pitot tubes.

The probe body is likely connected to a flange which can then be coupled directly to the pipeline, and pressure sensors coupled to the pitot tube through the flange body. The differential pressure output of the pitot tube would be connected to a corresponding differential pressure measuring instrument, providing an electrical signal output which is proportional to the flow rate.

The shape of the probe body of the pitot tube is such that a break point is generated at the upstream side, minimising turbulence generation, and thus, a stable pressure is generated at the downstream side of the probe body.

Given that the pitot tube is inserted into a fluid flow, there is a propensity for coherent vortex generation. Where the natural frequency of the pitot tube corresponds with the vortex shedding frequency, there may be additional supporting structures required to mitigate the effects of the vortices.

### SUMMARY

The present invention seeks to provide a solution to the above-mentioned problems due to vortex shedding in particular.

According to a first aspect of the invention, there is provided a pipeline insertion device comprising: an elongate device body having an outer surface comprising an in-use upstream portion an in-use downstream portion; and a plurality of fluid-flow-directing elements positioned on the outer surface of the elongate device body, the plurality of fluid-flow-directing elements being perimetrically offset to both the upstream portion and the downstream portion of the elongate device body.

The provision of the fluid-flow directing elements on the elongate body reduces the effects of coherent vortex shedding on the pipeline insertion device, reducing the need to provide additional stabilisation in the pipeline. However, it is not possible to provide fluid-flow-directing elements known in the art, since these would distort the dynamic pressure at the device, particularly for a pitot tube around its pitot openings, which has thus far prevented any solution to the problem of coherent vortex shedding to date. The limitation of the perimetric positioning of the fluid-flow-directing members within the present invention resolves this dilemma.

A perimetric dimension of the upstream portion and/or the downstream portion may be at least 5% of the perimetric extent of the elongate device body, or more preferably a perimetric dimension of the upstream portion and/or the downstream portion may be at least 10% of the perimetric extent of the elongate device body, and even more preferably a perimetric dimension of the upstream portion and/or the downstream portion may be at least 15% of the perimetric extent of the elongate device body, and most preferably, a perimetric dimension of the upstream portion and/or the downstream portion may be at least 20% of the perimetric extent of the elongate device body.

The greater the area of the upstream and downstream surfaces without fluid-flow-directing elements that is present on the outer surface of the elongate device body, the less likely it will be that the fluid-flow directing elements will interfere with the pitot pressure measurements.

A perimetric dimension of the upstream portion may, in some embodiments, be greater than, less than, or equal to a perimetric extent of the downstream portion.

Since the primary measurements for the pressure through a pitot tube are conducted via determination of the dynamic pressure at the upstream inlet or inlets, there is a greater danger of disturbance to flow by the fluid-flow-directing elements. As such, it is preferred that the upstream portion devoid of fluid-flow-directing elements be at least as large, if not larger, than the downstream portion. The reverse could also be true, however.

Optionally, at least one first fluid-flow-directing element of the plurality of said fluid-flow-directing elements may be positioned on a left-hand lateral-facing portion of the elongate device body, and at least one second fluid-flow-directing element of the plurality of said fluid-flow-directing elements may be positioned on a right-hand lateral-facing portion of the elongate device body.

It will be appreciated that flow can be diverted around either side of the upstream portion of the elongate body, and therefore having fluid-flow-directing elements on both sides of the device is clearly advantageous.

The at least one first fluid-flow-directing element may be asymmetrically positioned with respect to the at least one second fluid-flow-directing element. For example, the at least one first fluid-flow-directing element may direct fluid in a first at least in part vertical direction, and the at least one second fluid-flow-directing element may direct fluid in a second at least in part vertical direction which is different to the first at least in part vertical direction.

Asymmetry of the flow diversion may be helpful for avoiding coherent turbulence on the downstream side of the device, further improving the accuracy of measurements made.

Preferably, the lateral-facing portions may have a perimetric dimension which is at least 10% of the perimetric extent of the elongate device body, and more preferably, the lateral-facing portions may have a perimetric dimension which is at least 20% of the perimetric extent of the elongate device body, and most preferably, the lateral-facing portions may have a perimetric dimension which is at least 25% of the perimetric extent of the elongate device body.

There will be a minimum perimetric or circumferential span of the fluid-flow-directing elements which creates sufficient vortex shedding reduction, without impinging on the measurement capacity of the device. Segmentation of the device into quarters, that is, upstream, left, downstream, and right portions does appear to provide a suitable balance between these competing factors.

Preferably, a cross-section of the elongate device body is or is substantially: cylindrical; square; hexagonal; or otherwise geometrically uniform or regular.

Many tube shapes are feasible, and the only crucial criteria is that there not be significant flow disruption to the fluid in the pipeline.

Optionally, the upstream portion may be at least in part concave; convex; or flat.

Since the upstream portion is the side of the device which experiences the dynamic pressure, particular designs thereof, or indeed of the pitot tube openings themselves, may assist with fluid capture without creating additional turbulence.

The device may further comprise at least one sampling inlet for an upstream sampling tube on the in-use upstream portion for receiving a sample fluid therein, and preferably also at least one sampling outlet for a downstream sampling tube on the in-use downstream portion.

One viable type of device which could utilise the present fluid-flow directing capability is a sampling probe for fluid within a pipeline. Vortex shedding effects can be reduced using the present invention.

The device optionally further comprises a return conduit interconnecting the upstream sampling tube and the downstream sampling tube.

A return conduit of some form will complete the circuit for the sampling fluid, so that it can be readily returned to the primary pipeline flow.

The device also may further comprise a sample analysis apparatus for analysing the said sample fluid.

The device described thus far is readily capable of being used for inline sample analysis, simultaneously whilst taking differential pressure measurements via the pitot tube channels. This provides a unique and highly advantageous device when combined with myriad possible sample analysis systems.

Preferably, the pipeline insertion device may further comprise at least one upstream pitot tube opening on the in-use upstream portion and/or at least one downstream pitot tube opening on the in-use downstream portion.

Optionally, the upstream sampling tube and downstream sampling tube may be spaced apart from the upstream pitot tube and the downstream pitot tube.

The spacing apart of the pitot and sampling tube channels within the probe body advantageously allows for both to be utilised simultaneously, as well as providing space for additional sensor equipment within the device.

Preferably, the at least one upstream pitot tube opening may alternate with the at least one sampling inlet in a longitudinal direction of the elongate device body, and/or the at least one downstream pitot tube opening alternates with the at least one sampling outlet in a longitudinal direction of the elongate device body.

A combined pitot and sampling device can be readily created, by reconfiguration of some of the pitot openings into sampling ports. The great advantage of this arrangement is that, since there are already upstream and downstream openings in the elongate probe body, it becomes simple to divert a sampled flow through an upstream sampling tube and back into the main fluid flow through a downstream sampling tube, though this could of course be provided separately. Venting of the sampled fluid therefore becomes completely unnecessary. Alternating positioning of sampling and pitot openings on the elongate device body provides a convenient and space efficient of constructing the device.

The device may further comprise a bore. The bore may be a probe-receiving bore, in which case, the probe may optionally be a temperature sensor probe. Alternatively, the bore may be a sampling bore or an injection bore.

The provision of a probe may allow further utility for the device. In one desirable embodiment, this may allow for configuration of the device as a thermowell, whilst also retaining measurement capability, as well as potentially also sampling capability.

A probe device can be considered in which coherent vortex shedding effects are eliminated or significantly reduced, without needing to provide continuous fluid-flow-diverting elements around the entire perimeter. The present invention demonstrates that this can be achieved without a deleterious effect on the vortex-reducing capacity.

According to a second aspect of the invention, there is provided a combined pitot tube and sampling device for in-line flow rate measurement and sampling of a fluid in a pipeline, the combined pitot tube and sampling device comprising: an elongate probe body having an outer surface comprising an in-use upstream portion including at least one upstream pitot tube opening for an upstream pitot tube and an in-use downstream portion including at least one downstream pitot tube opening for a downstream pitot tube; and at least one sampling inlet for an upstream sampling tube on the in-use upstream portion for receiving a sample fluid therein.

A combined pitot tube and sampling device can be readily created, by reconfiguration of a pitot tube device such that some of the pitot openings are converted into sampling ports. The great advantage of this arrangement is that, since there are already upstream and downstream openings in the elongate probe body, it becomes simple to divert a sampled flow through an upstream sampling tube and back into the main fluid flow through a downstream sampling tube, though this could of course be provided separately. Venting of the sampled fluid therefore becomes completely unnecessary, all whilst utilising existing pitot tube geometry.

The combined pitot tube and sampling device may further comprise a plurality of fluid-flow directing elements positioned on the outer surface of the elongate probe body, the plurality of fluid-flow directing elements being perimetrically offset to both the upstream portion and the downstream portion of the elongate probe body.

A perimetric dimension of the upstream portion and/or the downstream portion may be at least 5% of the perimetric extent of the elongate probe body, or at least 10% of the perimetric extent of the elongate probe body, or at least 15% of the perimetric extent of the elongate probe body, or at least 20% of the perimetric extent of the elongate probe body.

Optionally, perimetric dimension of the upstream portion may be greater than or equal to a perimetric extent of the downstream portion.

A first plurality of said fluid-flow-directing elements may be positioned on a left-hand lateral-facing portion of the elongate probe body, and a second plurality of said fluid-flow-directing elements is positioned on a right-hand lateral-facing portion of the elongate probe body.

Preferably, the first plurality of fluid-flow-directing elements may be asymmetrically positioned with respect to the second plurality of fluid-flow-directing elements.

Optionally, the first plurality of fluid-flow-directing elements may direct fluid in a first at least in part vertical direction, and the second plurality of fluid-flow-directing elements direct fluid in a second at least in part vertical direction which is different to the first at least in part vertical direction.

Preferably, the lateral-facing portions may have a perimetric dimension which is at least 10% of the perimetric extent of the elongate probe body, or which is at least 20% of the perimetric extent of the elongate probe body, or which is at least 25% of the perimetric extent of the elongate probe body.

Optionally, a cross-section of the elongate probe body may be or substantially be: cylindrical; square; hexagonal; or otherwise geometrically uniform or regular.

The upstream portion may be at least in part concave; convex; or flat.

The combined pitot tube and sampling device may further comprise at least one sampling outlet for a downstream sampling tube on the in-use downstream portion for returning the sampled fluid.

Additionally, or alternatively, there may further comprise a return conduit interconnecting the upstream sampling tube and the downstream sampling tube.

The combined pitot tube and sampling device may further comprise a sample analysis apparatus for analysing the said sample fluid.

Optionally, the at least one upstream pitot tube opening may alternate with the at least one sampling inlet in a longitudinal direction of the elongate probe body, and/or the at least one downstream pitot tube opening alternates with the at least one sampling outlet in a longitudinal direction of the elongate probe body.

The combined pitot tube and sampling device may further comprise a bore.

Preferably, the bore may be a probe-receiving bore for receiving a probe therein.

Optionally, the probe may be a temperature sensor probe.

### BRIEF DESCRIPTION OF THE DRAWINGS

The invention will now be more particularly described, by way of example only, with reference to the accompanying drawings, in which:

FIG. 1 shows a front perspective representation of a first embodiment of a pitot tube device in accordance with the first aspect of the invention, which can also be used as a sampling probe device;

FIG. 2A shows a rear view of the pitot tube device of FIG. 1;

FIG. 2B shows a side view of the pitot tube device of FIG. 1;

FIG. 2C shows a front view of the pitot tube device of FIG. 1;

FIG. 3 shows a plan view of the base of the pitot tube device of FIG. 2B from direction A;

FIG. 4 shows a front perspective representation of a second embodiment of a combined pitot tube and sampling probe device in accordance with the first and second aspects of the invention;

FIG. 5A shows a side view of the pitot tube device of FIG. 4;

FIG. 5B shows a front view of the pitot tube device of FIG. 4;

FIG. 6A shows a plan view of the top of the pitot tube device of FIG. 5B from direction D;

FIG. 6B shows a horizontal cross-section taken through the pitot tube along line C-C of FIG. 5B;

FIG. 6C shows a horizontal cross-section taken through the pitot tube along line B-B of FIG. 5B; and

FIG. 7 shows a front perspective representation of a generic measurement probe device in accordance with the third aspect of the invention;

FIG. 8 shows a front perspective representation of a further embodiment of a sampling probe device in accordance with the first aspect of the invention, which can also be used as a pitot tube device;

FIG. 9A shows a front view of the sampling probe device of FIG. 8;

FIG. 9B shows a side view of the sampling probe device of FIG. 8;

FIG. 9C shows a rear view of the sampling probe device of FIG. 8

FIG. 10 shows a horizontal cross-section taken through the sampling probe device along line A-A of FIG. 9A;

FIG. 11 shows a front perspective representation of a further embodiment of a pitot tube device in accordance with the first aspect of the invention, which can also be used as a sampling probe device;

FIG. 12 shows a front view of the pitot tube device of FIG. 11;

FIG. 13 shows a horizontal cross-section taken through the pitot tube device along line A-A of FIG. 12;

FIG. 14 shows a lower front perspective view of a further embodiment of a pitot tube device in accordance with the first aspect of the invention, which can also be used as a sampling probe device;

FIG. 15A shows a side view of the pitot tube device of FIG. 14;

FIG. 15B shows a front view of the pitot tube device of FIG. 14;

FIG. 16 shows a horizontal cross-section taken through the pitot tube device along line A-A of FIG. 15B;

FIG. 17 shows an indicative alternative cross-section through a further embodiment of pitot tube device in accordance with the first aspect of the invention, which can also be used as a sampling probe device;

FIG. 18 shows an indicative alternative cross-section through a further embodiment of pitot tube device in accordance with the first aspect of the invention, which can also be used as a sampling probe device;

FIG. 19 shows an indicative alternative cross-section through a further embodiment of pitot tube device in accordance with the first aspect of the invention, which can also be used as a sampling probe device;

FIG. 20 shows an indicative alternative cross-section through a further embodiment of pitot tube device in accordance with the first aspect of the invention, which can also be used as a sampling probe device;

FIG. 21 shows a front perspective representation of a first embodiment of an injection quill device in accordance with the first aspect of the invention;

FIG. 22A shows the injection quill device of FIG. 21 configured to inject fluid sample in an upstream direction of fluid flow in a pipeline; and

FIG. 22B shows the injection quill device of FIG. 21 configured to inject fluid sample in a downstream direction of fluid flow in a pipeline.

### DETAILED DESCRIPTION

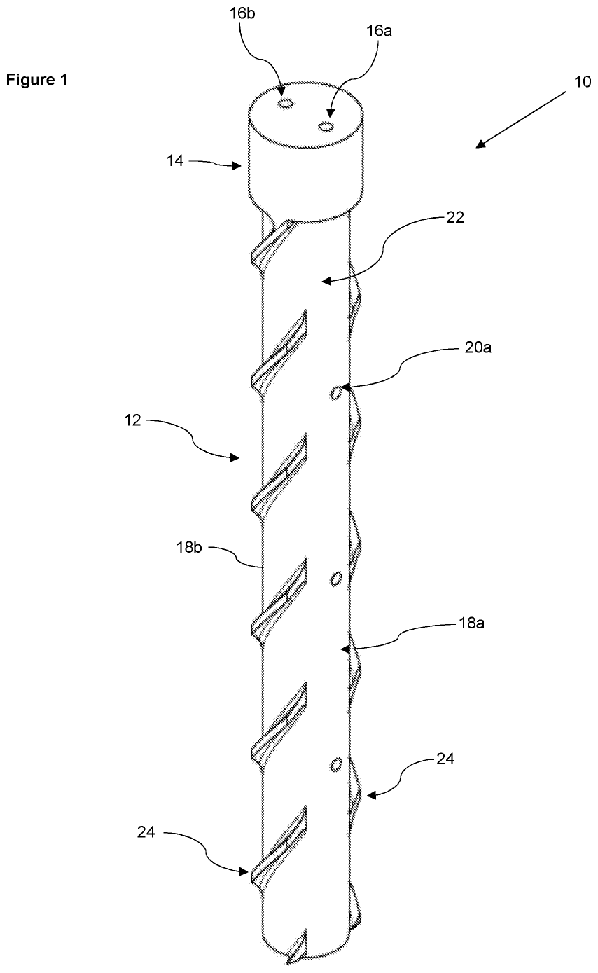

Referring firstly to FIG. 1 there is shown a pitot tube device, referenced globally at 10 and which is suitable for taking flow rate measurements within a moving fluid source, such as a natural gas pipeline. The device 10 may itself commonly be referred to as a pitot tube. Note that a pitot tube is provided as an initial example of a pipeline insertion device, that is, a device inserted into a pipeline, such as a liquid natural gas pipeline, during operation. Other pipeline insertion devices are discussed in detail below.

The pitot tube device 10 comprises an elongate probe body 12 which is designed to be inserted into the flow of the fluid, perpendicular or substantially perpendicular to a direction of flow of the said fluid being transported. At one end of the elongate probe body 12 there is provided a head portion 14 which allows for coupling of the pitot tube device 10 to onward pressure sensing equipment which is configured to measure the differential pressure between first and second pitot tube channels 16a, 16b of the pitot tube device 10.

The first pitot tube channel 16a is provided as an upstream pitot tube channel, having a plurality of upstream pitot tube openings 20a on an in-use upstream portion 18a of the elongate probe body 12. The second pitot tube channel 16b is then provided as a downstream pitot tube channel, with at least one, and perhaps a plurality of downstream pitot tube openings 20b on an in-use downstream portion 18b of the elongate body 12. The respective first and second pitot tube channels 16a, 16b allow for differential pressure measurements to be determined which are indicative of a fluid flow rate in the conduit into which the pitot tube device 10 has been installed. It will be apparent that the first pitot tube channel 16a could function with a single upstream pitot tube opening, and similarly that the second pitot tube channel 16b could function with a single downstream pitot tube opening 20b, but that a plurality of upstream and downstream pitot tube openings 20a, 20b in communication with the first and second pitot tube channels 16a, 16b respectively improves the quality of measurement. This is particularly true for the plurality of upstream pitot tube openings 20a, since this allows for averaging of the pressure measured along the longitudinal dimension of the elongate probe body 12.

The in-use upstream portion 18a and in-use downstream portion 18b can be defined as the portions of the outer surface 22 of the elongate probe body 12 on which the pitot tube openings 20a, 20b are located, with a perimetric or circumferential dimension of the pitot tube openings 20a, 20b, typically the diameter D_{PTO} of the pitot tube openings 20a, 20b, defining the minimum dimension of the in-use upstream portion 18a and in-use downstream portion 18b. However, it is preferred that the in-use upstream portion 18a and in-use downstream portion 18b have a perimetric or circumferential dimension which is at least 2D_{PTO}, and more preferably at least 3D_{PTO}.

The terms perimetric and circumferential are used interchangeably here. Whilst the elongate probe body 12 illustrated is cylindrical, and therefore the term circumference is appropriate, it will be apparent that any divergence from a cylindrical shape would render this terminology inconsistent. Examples of other shapes include; square; hexagonal; or otherwise uniform or regular geometric shapes.

Extending from the outer surface 22 of the elongate probe body 12 is a plurality of fluid-flow-directing elements 24, located between the in-use upstream portion 18a and in-use downstream portion 18b, so as to be perimetrically offset therefrom. In other words, the fluid-flow-directing elements 24 do not extend into the in-use upstream portion 18a and in-use downstream portion 18b.

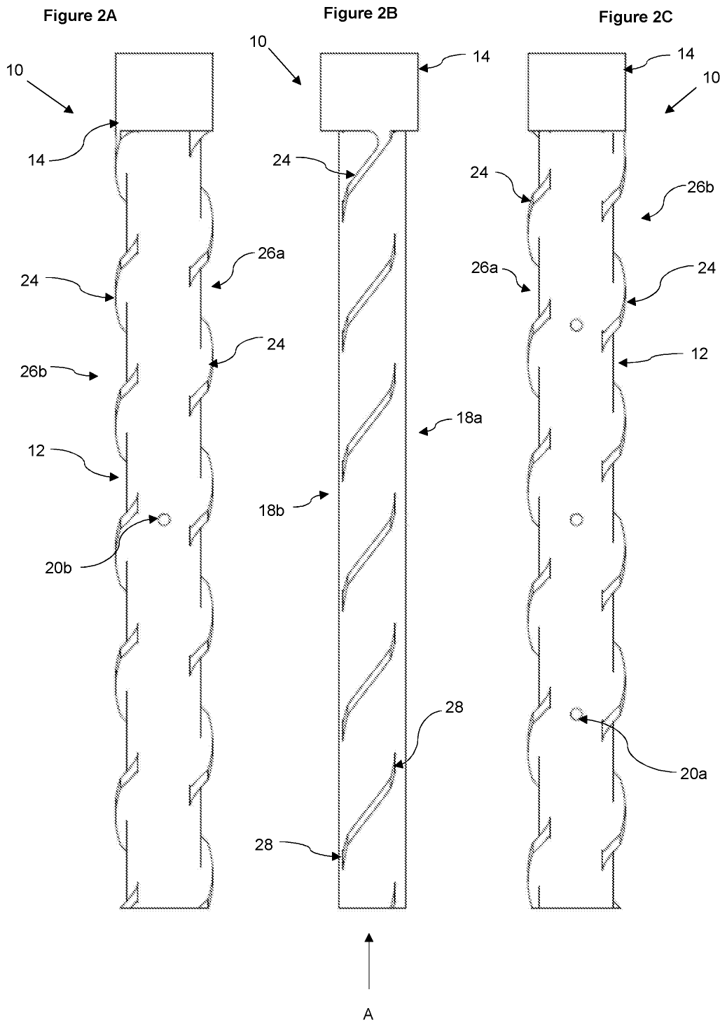

The fluid-flow-directing elements 24, seen best in FIGS. 2A, 2B and 2C may be formed as baffles, strakes, or fins, which have a rectilinear or substantially rectilinear cross section. At least one, and preferably a plurality of the fluid-flow-directing elements 24 are provided in a spaced-apart manner on each side of the in-use upstream portion 18a and in-use downstream portion 18b. It is therefore possible to define left- and right-hand sides 26a, 26b of the elongate probe body 12 by reference to the areas in which the fluid-flow-directing elements 24 are present. This spacing can be seen best in FIGS. 2A, 2B and 2C. Whilst the fluid-flow-directing elements 24 are shown extending along the length of the elongate probe body 12, they may be positioned only on part thereof, typically the distalmost tip of the elongate probe body positioned inside the pipeline.

The upstream pitot tube openings 20a can be seen in FIG. 2C, of which there are three. This allows for an averaging pressure measurement to be taken, improving the accuracy of the fluid flow calculation. There is, in this embodiment, only a single downstream pitot tube opening 20b, though more than one pitot tube opening could be provided as noted above.

The fluid-flow-directing elements 24 of the left- and right-hand sides 26a, 26b may be staggered relative to one another in a vertical direction. The fluid-flow-directing elements 24 of the left- and right-hand sides 26a, 26b may additionally or alternatively have fluid-directing surfaces which direct the fluid flowing thereacross which are oriented in different vertical directions. This is best illustrated in FIG. 2C, in which the fluid-flow-directing elements 24 of the left-hand side 26a direct fluid downward, and the fluid-flow-directing elements 24 of the right-hand side 26b direct fluid upward, with respect to the head portion 14.

Whilst the fluid-flow-directing elements 24 may be rectilinear or substantially rectilinear in cross section when viewed from the left- and right-hand sides 26a, 26b respectively, the curvature of the outer surface 22 of the elongate probe body 12 is such that leading and/or trailing edges 28 of the fluid-flow-directing elements 24 may not themselves be rectilinear.

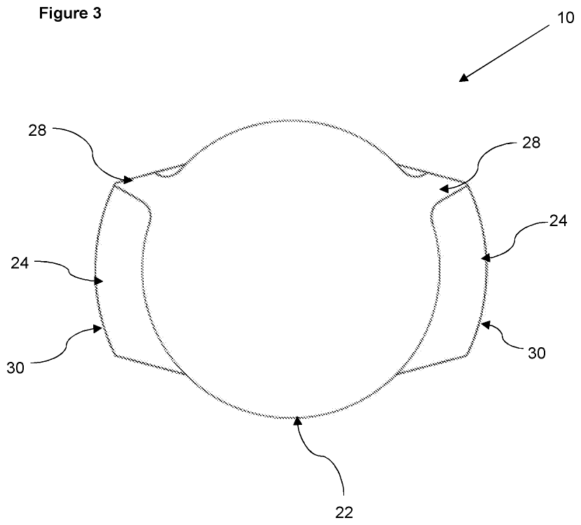

When viewed along the axial direction, the shape of the fluid-flow-directing elements 24 can be seen in more detail, as illustrated in FIG. 3. A lateral or radial extent R_{FFDE} Of the fluid-flow-directing elements 24 relative to the outer surface 22 of the elongate probe body 12 may preferably be in the range of 0.2 to 0.5 times the radius R_{EPB} or lateral dimension of the elongate probe body 12, and more preferably in the range of 0.3 to 0.4 R_{EPB}. The outer edge 30 of each fluid-flow-directing elements 24 may preferably be arcuate, and may more preferably follow a circumference of a circle having radius R_{EPB}+R_{FFDE}.

The fluid-flow-directing elements 24 shown are only illustrative embodiments. The fluid-flow-directing elements could be formed so as not to be staggered on the left- and right-hand sides. The fluid-flow-directing elements could be formed so as to direct flow on the left- and right-hand sides in the same vertical or axial direction, rather than in opposite vertical directions as illustrated. The fluid-flow-directing elements could be formed so as to not have a rectilinear cross-section, and could instead have a more traditional thin blade configuration, or may form interrupted helical strakes. Any appropriate shape or form of fluid-flow directing element could be provided without diverting from the scope of the present invention; that is, providing said fluid-flow directing elements are only on the lateral portions of the elongate probe body with respect to the anticipated direction of fluid flow during use.

The pitot tube device 10 is designed for use in fluid flow measurement. However, it will be apparent that the device could equally be used for sampling of the fluid for alternative analysis. If the device 10 were connected to a return conduit or similar apparatus, then flow through the upstream tube channel 16a could be configured to flow back into the main flow via the downstream tube channel 16b. This would make the pitot tube device 10 suitable for use as a generic sampling probe device 10. As such, fluid sampling could be achieved inline, and if a sample analysis apparatus were provided on the return conduit, then no venting of the sample to atmosphere would be required.

The term return conduit is used here for the connection between the upstream inlet tube 16a and the downstream outlet tube 16b, but this is only intended to refer to any fluid flow means which allows the return of the sampled fluid back to process. No specific structural limitation is therefore intended.

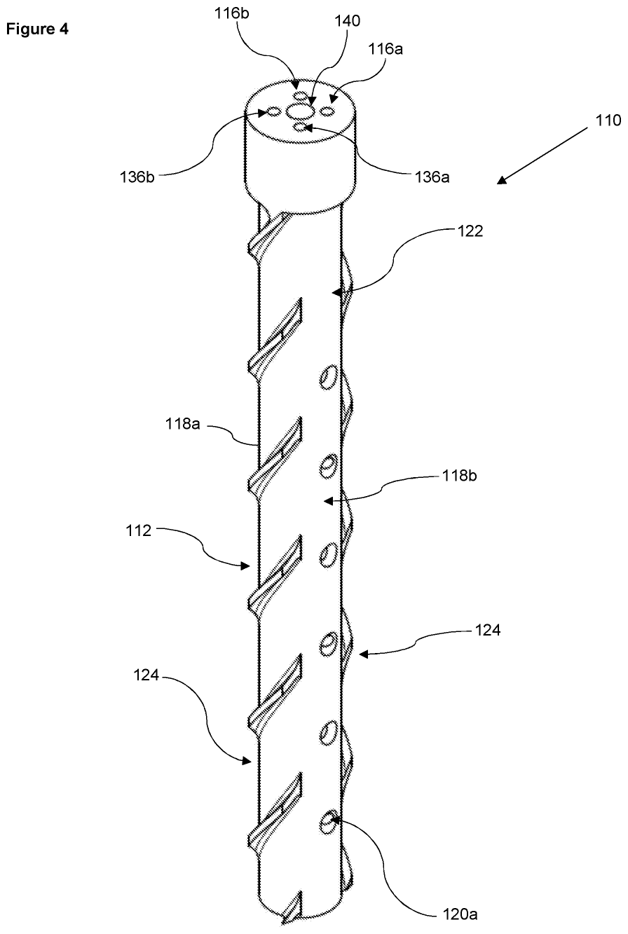

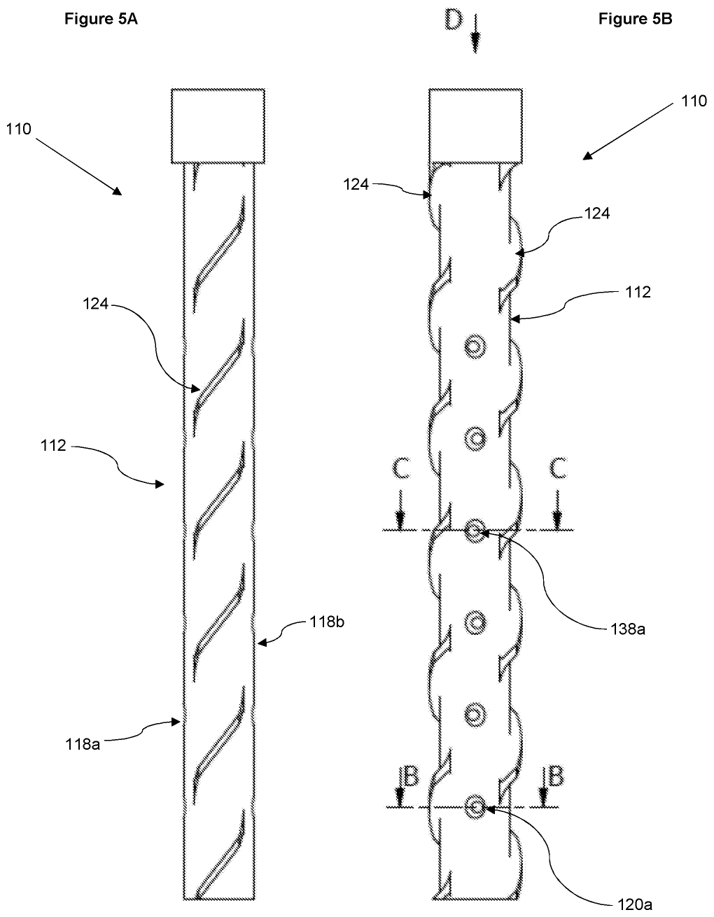

A second embodiment of pitot tube device is illustrated in FIGS. 4, 5A, and 5B, referenced globally at 110. Identical or similar features of the second embodiment will be referenced using identical or similar reference numerals used in the first embodiment, and further detailed description is omitted for brevity.

The fluid-flow-directing elements 124 in this pitot tube device 110 are identical to those described in relation to the first embodiment.

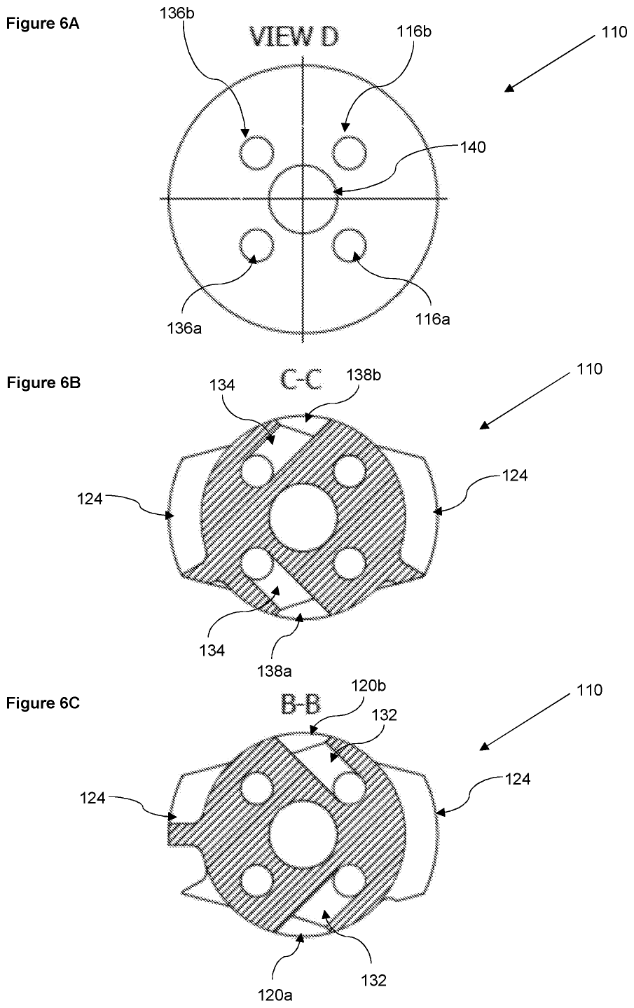

The pitot tube device 110 has two pitot tube channels, best seen in FIG. 6A; one upstream pitot tube channel 116a and one downstream pitot tube channel 116b. The pitot tube openings 120a, 120b communicable with the pitot tube channels 116a, 116b remain linearly aligned with one another, and therefore the pitot tube inlet paths 132 leading to the respective pitot tube channels 116a, 116b extend at an angle to an expected flow direction within the elongate probe body 112. This is best illustrated in FIGS. 6B and 6C.

The pitot tube device 110 also has two sampling tubes, also seen in FIG. 6A; one upstream sampling tube 136a and one downstream sampling tube 136b. There is then at least one corresponding sampling inlet 138a positioned on the upstream portion 118a of the elongate probe body 112, and at least one corresponding sampling outlet 138b positioned on the downstream portion 118b of the elongate probe body 112, respectively connected to the sampling inlets 138a, 138b by sampling tube inlet paths 134.

The pitot tube openings 120a, 120b and sampling inlets and outlets 138a, 138b alternate in the vertical or longitudinal direction of the elongate body, such that flow is diverted alternatingly between the upstream and downstream pitot tube channels 116a, 116b and the upstream and downstream sampling tubes 136a, 136b. It is preferred that the sampling inlets and outlets 138a, 138b be vertically aligned with one another, as shown in FIG. 6B, and that the upstream and downstream pitot tube openings 120 are also vertically aligned, as illustrated in in FIG. 6C.

It is, of course, possible to provide sampling inlets 138a on the elongate probe body 112, whilst eliminating the sampling outlets, in which case, there may be some alternative return or process conduit which receives the sampled fluid from the upstream sampling tube 136a. Such a return conduit could be completely separate from the pitot tube device 110.

A combined pitot and sampling device allows for fluid flow measurements to be taken via the differential pressure measured across the pitot tube channels 116a, 116b, whilst simultaneously being able to take and return a fluid sample for analysis without requiring any venting of the pitot tube device 110. This is extremely powerful, particularly for fluid sampling applications where there is significant risk of venting of the sample to the environment. For instance, sampling of natural gas traditionally releases methane into the atmosphere, which is a powerful greenhouse gas.

An axial bore 140 is provided within the elongate probe body 112, which allows for the insertion of an alternative probe type into the pitot tube device 110. This may then allow for combination sensing of properties of the fluid being measured. For instance, a temperature sensor probe could be inserted into the axial bore 140, which allows the pitot tube device 110 to act as a thermowell. It is noted that the bore could be provided off-axis within the elongate probe body 112, though this may be more complex to manufacture.

Whilst the axial bore 140 is illustrated as a probe-receiving bore, it will be appreciated that sampling bores are well known in the art, and such an arrangement could readily be achieved here. In this case, the axial bore would extend through the base of the elongate probe body 120, so that fluid could be sampled from the pipeline directly, without needing to make modifications to the upstream or downstream portions 118a, 118b of the pitot tube device 110.

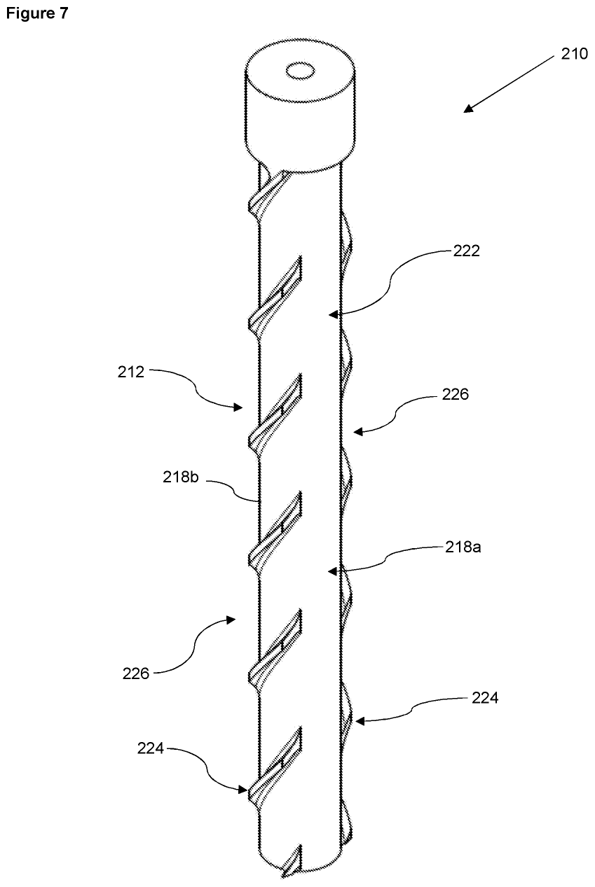

This concept can thus be extended further, as illustrated by the measurement probe device of FIG. 7, referenced globally at 210. Identical or similar features of this embodiment will be referenced using identical or similar reference numerals to those previously utilised, and further detailed description is omitted for brevity.

A generic measurement probe device 210 can thus be provided having an elongate probe body 212, which could be susceptible to vortex shedding effects. The presence of fluid-flow-directing elements 224 on lateral sides of the elongate probe body 224 is therefore capable of mitigating the effects of vortex shedding without needing to provide continuous strakes about the elongate probe body 212, as is the case in the art. This may provide many advantages, as different types of sensing could be achieved.

The absence of pitot tube openings in the elongate probe body 212 however warrants further discussion of the definition of the location of the fluid-flow-directing elements 224.

There is an in-use upstream portion 218a and in-use downstream portion 218b of the elongate probe body 212, which can be defined as the portions of the outer surface 222 of the elongate probe body 212 which are in-use upstream and downstream when the measurement probe device 210 is inserted into a fluid flow.

The fluid-flow-directing elements 224 can thus be considered to be on lateral-facing portions 226 of the elongate probe body 212, which are non-overlapping with the in-use upstream portion 218a and in-use downstream portion 218b.

In a preferred embodiment, the perimetric or circumferential extent of the in-use upstream portion 218a and/or the in-use downstream portion 218b is at least 5% of the total perimeter or circumferential extent of the elongate probe body 212. Preferably the perimetric extent of the upstream portion 218a and the in-use downstream portion 218b is equal.

In a more preferred embodiment, the perimetric or circumferential extent of the in-use upstream portion 218a and/or the in-use downstream portion 218b is at least 10% of the total perimeter or circumferential extent of the elongate probe body 212, and in an even more preferred embodiment, the perimetric or circumferential extent of the in-use upstream portion 218a and/or the in-use downstream portion 218b is at least 15% of the total perimeter or circumferential extent of the elongate probe body 212, and in an even more preferred embodiment, the perimetric or circumferential extent of the in-use upstream portion 218a and/or the in-use downstream portion 218b is at least 20% of the total perimeter or circumferential extent of the elongate probe body 212.

By extension, the perimetric or circumferential extent of each lateral-facing portion 226 is at least 10% of the total perimeter or circumferential extent of the elongate probe body 212, more preferably at least 20% of the total perimeter or circumferential extent of the elongate probe body 212, and most preferably at least 25% of the total perimeter or circumferential extent of the elongate probe body 212.

These dimensional relationships are applicable to measurement probe devices 210 in general, but it will be apparent that such relationships are equally applicable to the earlier-described pitot tube devices 10; 110.

The remaining Figures disclose further optional embodiments of the invention, which can be utilised for pitot tube devices, sampling probe devices, and/or generic measurement devices, and the skilled person will appreciate the interchangeability of the features disclosed hereafter.

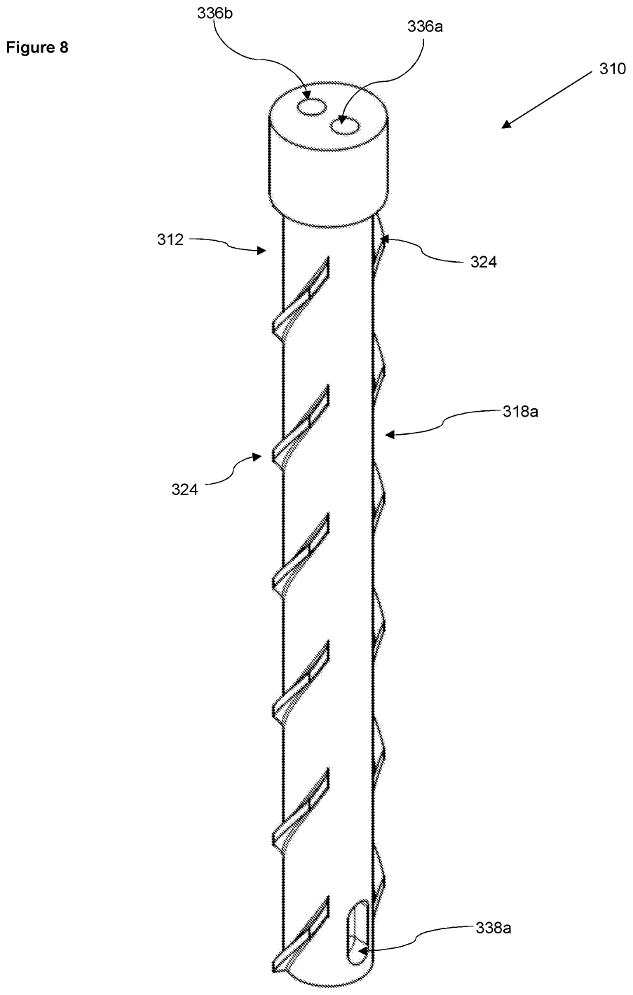

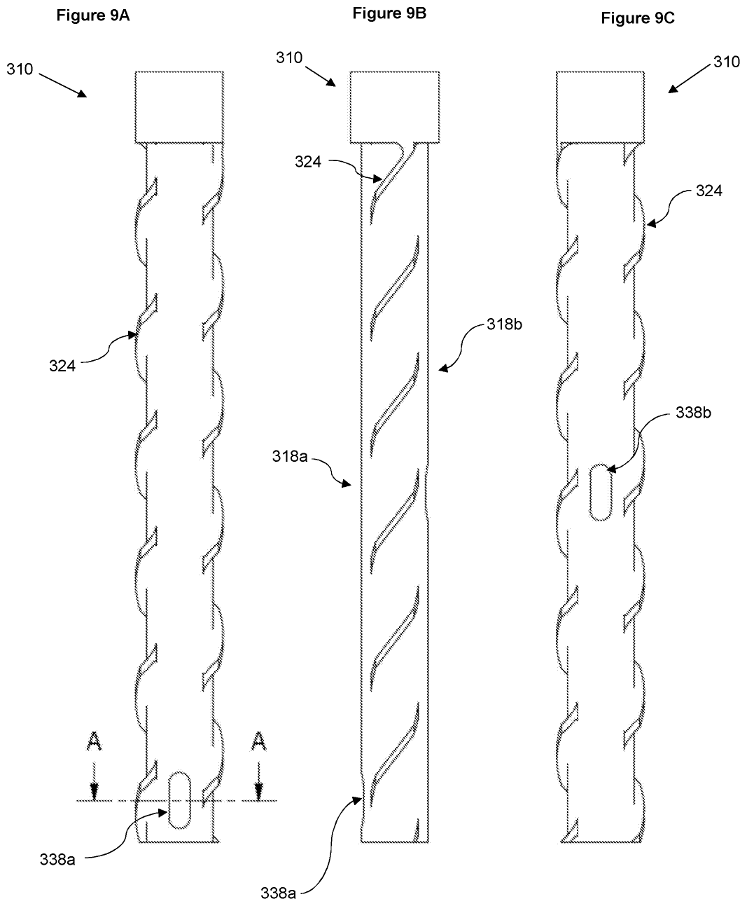

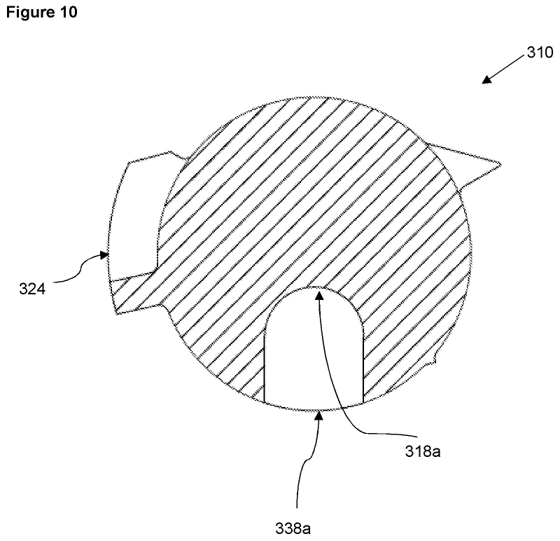

FIGS. 8, 9A, 9B, 9C, and 10 disclose a sampling tube device, referenced globally at 310.

On the upstream portion 318a, there is a single sampling tube opening 338a which has a sampling tube inlet path 334 shaped as a scoop to assist with direction of flow up into the upstream sampling tube 336a. The downstream sampling tube 336b then extends into a similarly shaped sampling tube opening 338b, though there is no need for the upstream and downstream sampling tube openings 338a, 338b to have the same shape or size. The downstream sampling tube opening 338b, in particular, is less critical to performance of the sampling tub device 310.

The downstream sampling tube opening 338b is here shown as being positioned at a different longitudinal position on the elongate probe body 312 relative to the upstream sampling tube opening 338a, though the upstream and downstream sampling tube openings 338a, 338b could both be at the same longitudinal position. The principal factor is that the fluid-flow-directing elements 324 not encroach onto the upstream and/or downstream sampling tube openings 338a, 338b.

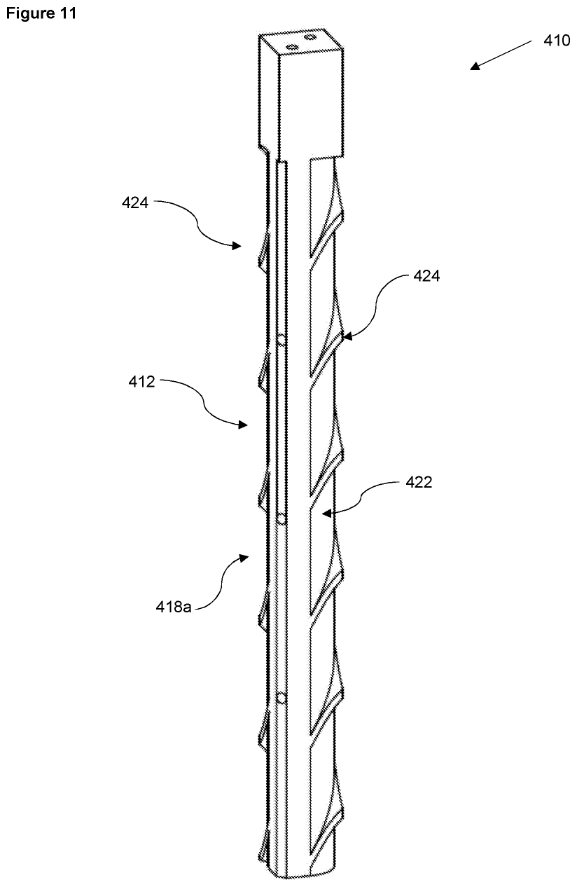

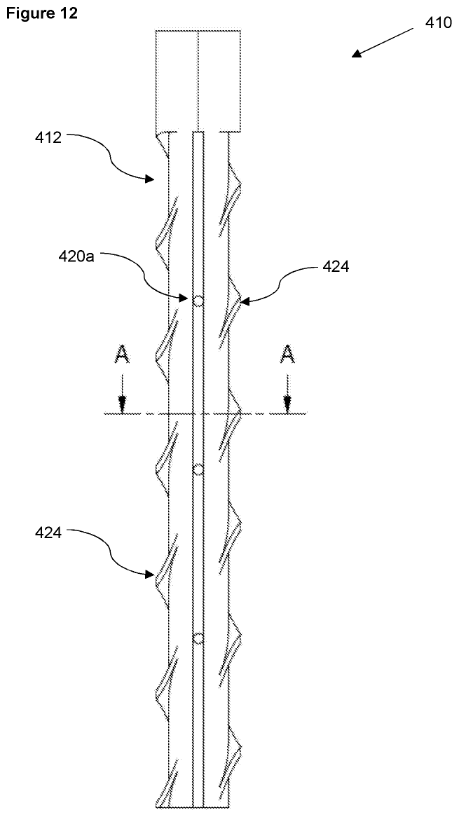

FIGS. 11, 12, and 13 show a further alternative pitot tube device, referenced globally at 410.

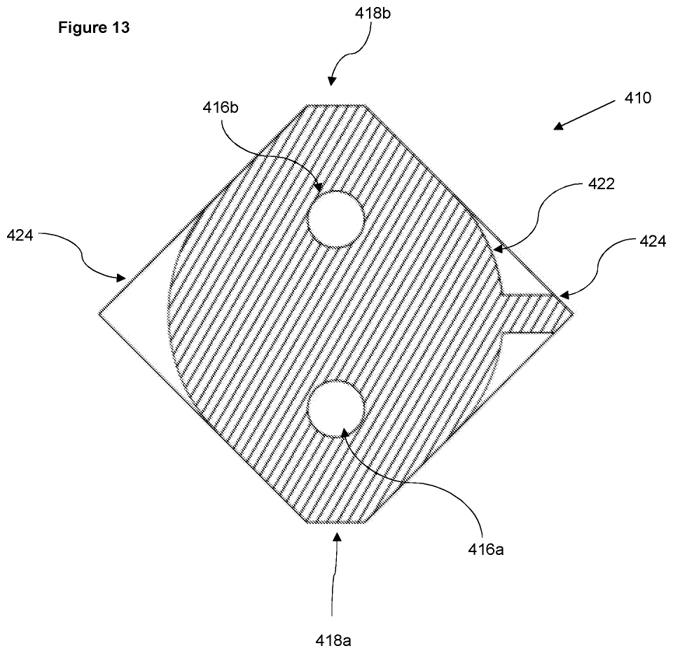

Rather than being designed so as to have a cylindrical profile, the cross-section of the elongate probe body 412 is square or substantially square, with the upstream portion 418a being positioned on or adjacent to a leading edge of the square shape, which is chamfered in FIG. 13, and the downstream portion 418b being positioned on or adjacent to the trailing edge of the square shape, with respect to the fluid flow direction.

The chamfering may be provided such that the machining of the upstream pitot tube openings 420a and the downstream pitot tube openings is more straightforward to achieve, particularly as machining to join with the respective pitot tube channels 416a, 416b becomes quite challenging through a pointed edge of a square profile.

The fluid-flow-directing elements 424 are themselves shaped to the outer dimensions of the square shape, and indeed, the pitot tube device could be machined from a square bar of material, with the outer surface 422 of the elongate probe body 412 being machined down to have a substantially cylindrical profile to improve the fluid flow characteristics thereacross.

It will be appreciated that there are many possible cross-sectional designs for the elongate probe body, some of which are explored below, and the description herein does not constitute an exhaustive summary of possible configurations.

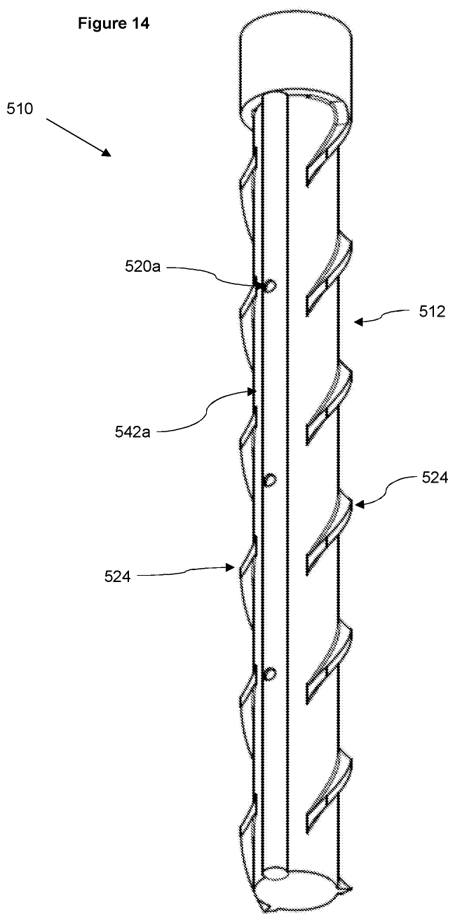

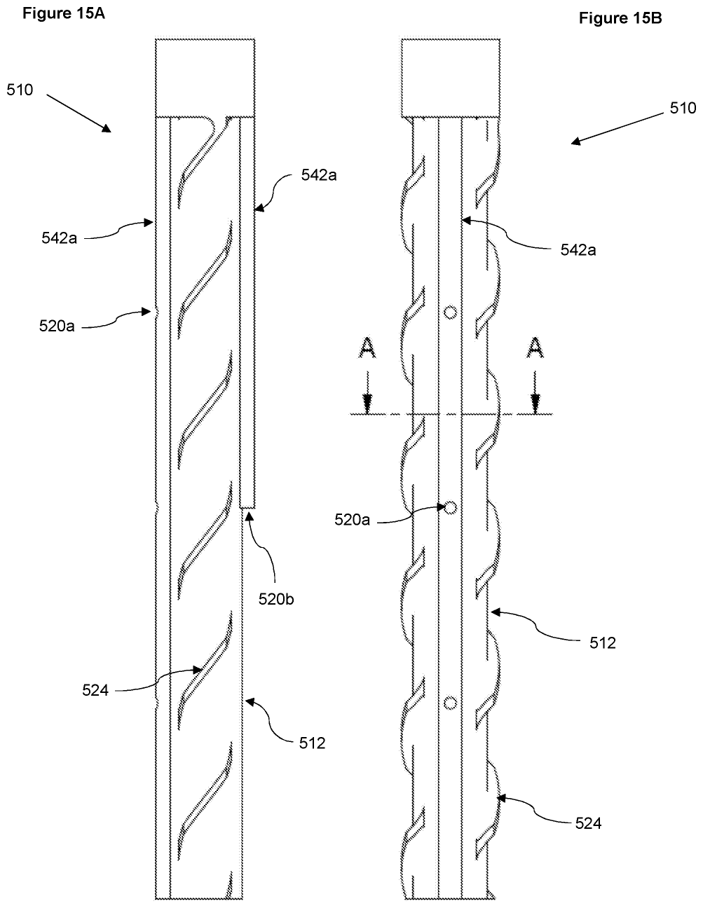

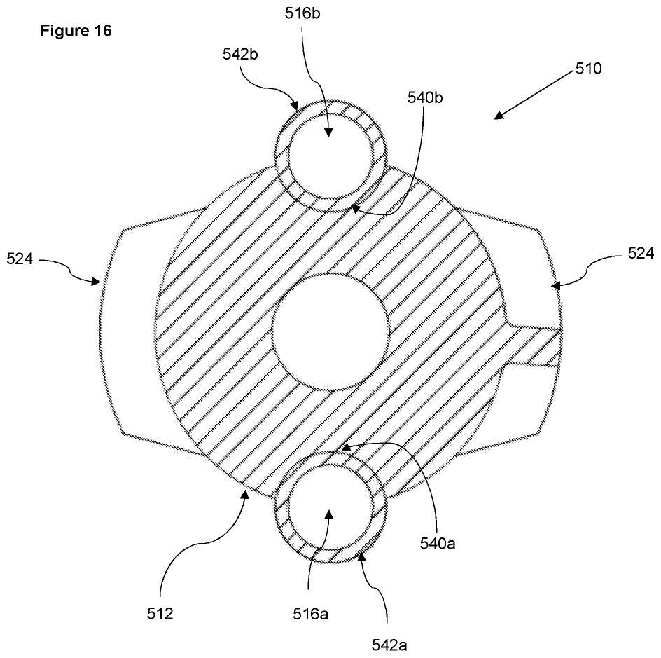

A further pitot tube device is shown in FIGS. 14, 15A, 15B, and 16, referenced globally at 510. This pitot tube device 510 can be assembled without the need for complex machining of the elongate probe body 512 to form the upstream and downstream pitot tube channels 516a, 516b.

The elongate probe body 512 includes upstream and downstream machined grooves 540a, 540b into which are respectively receivable upstream and downstream tubes 542a, 542b. The upstream and downstream tubes 542a, 542b thus carry the pitot tube channels 516a, 516b. A plurality of upstream pitot tube openings 520a are positioned on the outer surface of the upstream tube 542a. The upstream and downstream tubes 542a, 542b may be welded or otherwise fixedly connected to the elongate probe body 512 to assemble the pitot tube device 510.

The downstream pitot tube opening 520b, on the other hand, is merely an aperture at the end of the downstream tube 524b, and since the downstream tube 542b is shorter than the upstream tube 542a, allowing discharge from the downstream pitot tube opening 520b to occur at a different longitudinal position relative to the upstream pitot tube openings 520a.

The positions of the upstream and downstream tube 542a, 542b provide clear delimiters for the maximum perimetric positions of the fluid-flow-directing elements 524.

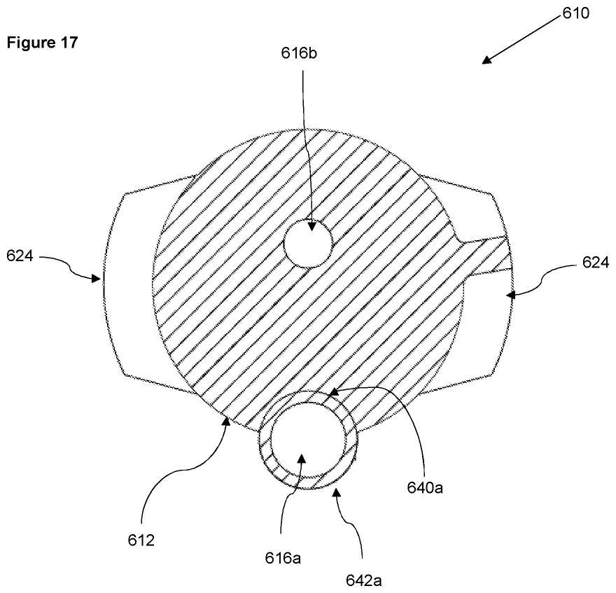

An alternative yet similar embodiment is shown in FIG. 17, where the pitot tube device is referenced globally at 610. There is an upstream machined groove 640a on the elongate probe body 612 into which is receivable the upstream tube 642a carrying the pitot tube channel 616a. However, the downstream pitot tube channel 616b in the depicted embodiment is instead integrally formed with the elongate probe body 612.

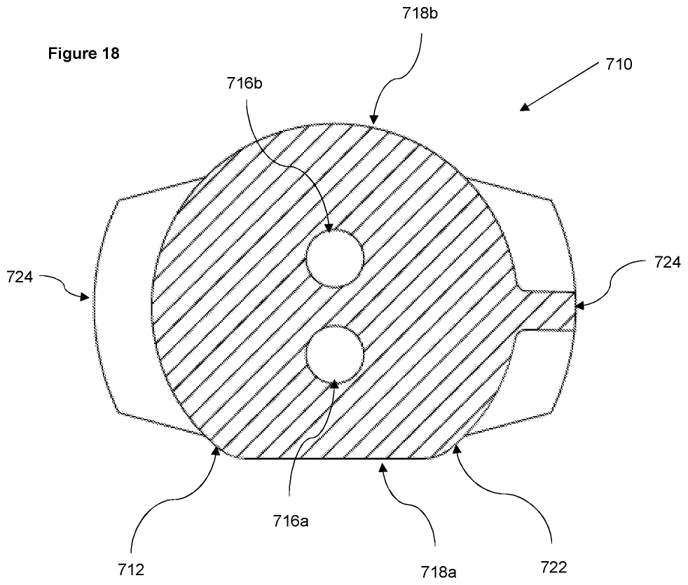

Further cross-sectional options for a pitot tube device are illustrated in FIGS. 18 to 20. FIG. 18 shows a pitot tube device 710 in which the upstream and downstream portions 718a, 718b have different surface shapes. The upstream and downstream pitot tube channels 716a, 716b remain unaffected by the alteration of the outer surface 722. The fluid-flow-directing elements 724 remain perimetrically offset relative to both the upstream and downstream portions 718a, 718b.

Changes to the upstream portion 718a may alter the fluid capture properties of the pitot tube device 710, making improved fluid flow measurements possible

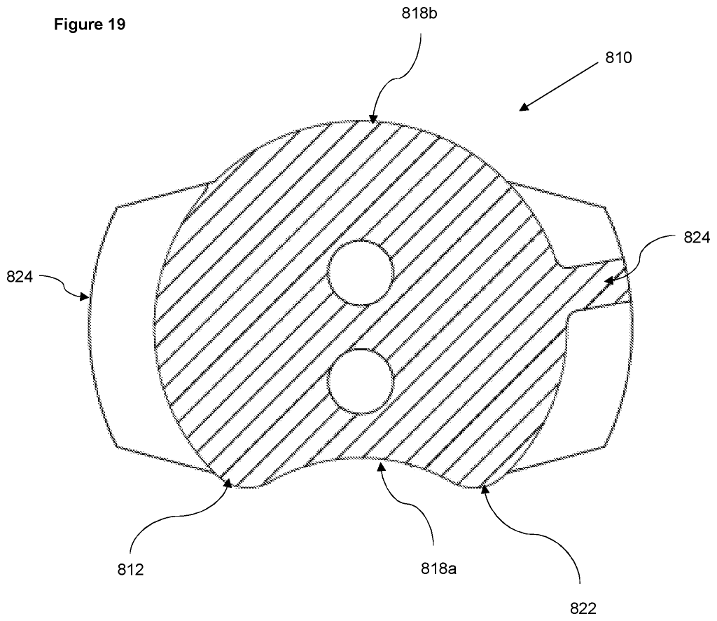

This can be further continued with reference to the embodiment of FIG. 19, in which the pitot tube device 810 has an outer surface 822 including a concave upstream portion 818a of the elongate probe body 812, a convex downstream portion 818b, and fluid-flow-directing elements 824 at lateral portions relative to the upstream and downstream portions 818a, 818b.

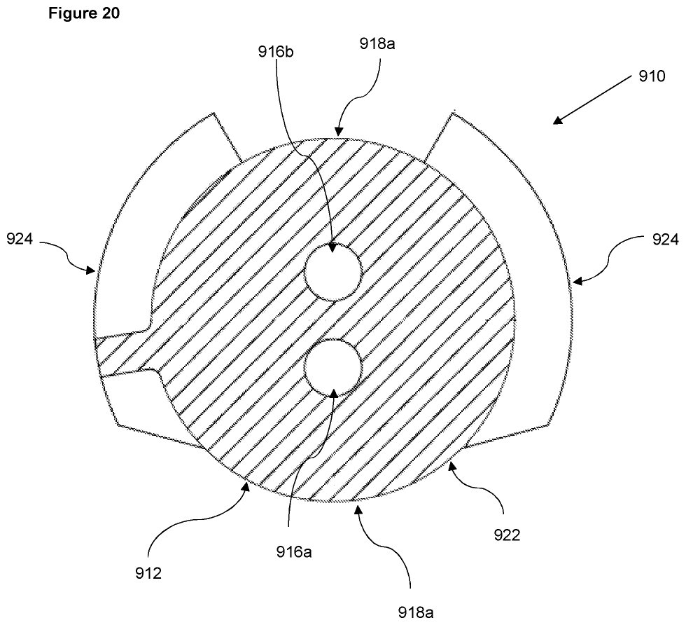

FIG. 20 shows an asymmetric pitot tube device 910 with respect to the fluid-flow-directing elements 924. The elongate probe body 912 remains cylindrical, and the upstream portion 918a covers approximately 25% of the perimetric extent of the outer surface 922. In angular terms, the upstream portion 918a covers an angular range of approximately 90°. This provides ample space such that the fluid-flow-directing elements 924 do not impede flow into the upstream pitot tube channel 916a.

Flow interruption or turbulence is less crucial for the downstream pitot tube channel 916b than the upstream pitot tube channel 916a. As such, the fluid-flow-directing elements 924 can encroach to a greater perimetric extent towards the downstream portion 918b. In the depicted embodiment, the downstream portion 918b has a perimetric extent less than that of the upstream portion 918a, which is here approximately 16.67%, or one sixth, of the total perimetric extent of the outer surface 922, equating to an angular range of 60°.

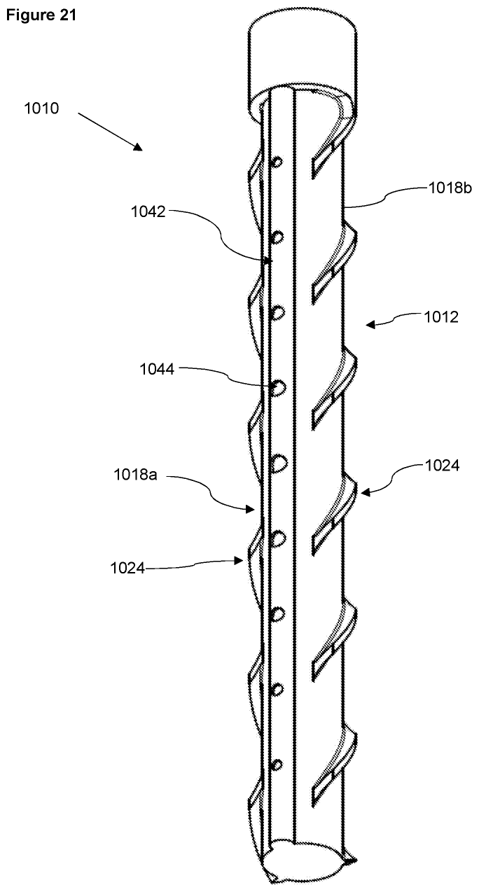

FIG. 21 shows an injection quill device, referenced globally at 1010, having fluid-flow-directing elements 1024 as per the previous embodiments of the invention. The injection quill device 1010 has an outer surface 1022 of its elongate device body 1012 having first and second portions 1018a, 1018b. On the first portion 1018a, there is an injection channel 1042 having a plurality of injection outlets 1044 via which a fluid sample can be injected into the stream of a pipeline during use.

In the depicted embodiment, the injection outlets 1044 have different aperture dimensions, increasing in size towards a longitudinal centre of the elongate device body 1012. This may allow for correct injection rate based on fluid flow velocity within the pipeline. Of course, uniform dimensions of injection outlet could readily be provided.

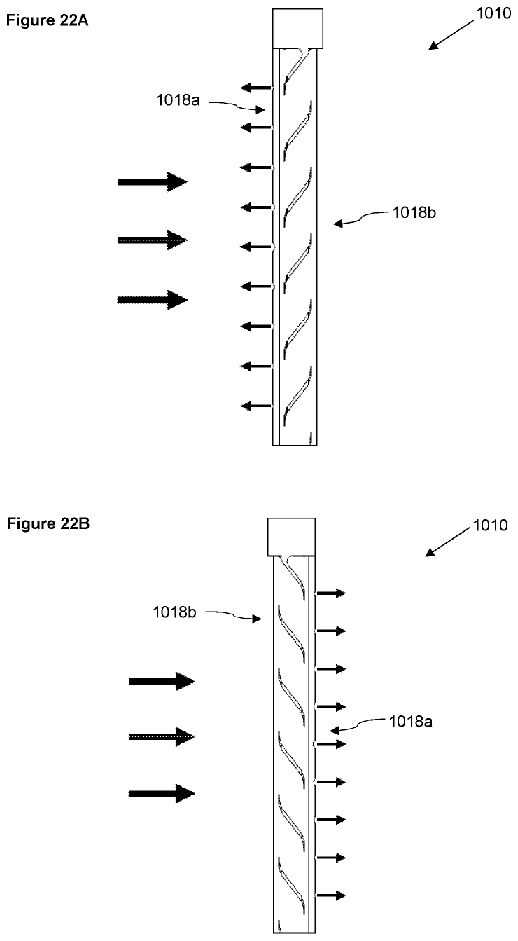

FIGS. 22A and 22B show different options for positioning of the injection quill device 1010 in a pipeline. In FIG. 22A, the plurality of injection outlets 1044 face into the oncoming fluid flow, whereas in FIG. 22B, the plurality of injection outlets 1044 face in the downstream direction. Either option is feasible, depending on the desired operational requirements.

One possible use of this injection quill device may be for injection of hydrogen gas, H₂, into a natural gas pipeline, for distribution into the existing commercial or domestic gas supply.

It is possible to provide any or all of the pitot tube, sampling tube, measurement and/or other pipeline insertion devices disclosed herein as retractable devices, in which a longitudinal projection into the fluid flow pipeline can be altered. Furthermore, this has the advantage of being able to insert the device into the pipeline without causing depressurisation. This would typically be provided by means of a linear actuator or slider which allowed for alteration of the depth of the device in use without needing to access and shut off the pipeline section.

It is therefore possible to provide a pitot tube device which is capable of acting as a differential pressure sensor for fluid flow measurement, which also obviates issues with vortex shedding. Supporting structures in the pipeline can thus be eliminated. Said pitot tube device is also capable of being used as a sampling probe device, or can be modified to simultaneously act as a pitot tube and sample probe. The advantage of such a device in sampling contexts is that there is no need to vent the sample; the sample can be returned to process via the downstream tube. Furthermore, said device can be further improved with other sensing or measurement capabilities, including but not limited to acting as a thermowell, as well as other pipeline insertion devices such as injection quills.

The words ‘comprises/comprising’ and the words ‘having/including’ when used herein with reference to the present invention are used to specify the presence of stated features, integers, steps, or components, but do not preclude the presence or addition of one or more other features, integers, steps, components, or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A pipeline insertion device comprising:
an elongate device body having an outer surface comprising an in-use upstream portion and an in-use downstream portion; and
a plurality of fluid-flow-directing elements positioned on the outer surface of the elongate device body, the plurality of fluid-flow-directing elements being perimetrically offset to both the upstream portion and the downstream portion of the elongate device body.

2. (canceled)

3. A pipeline insertion device as claimed in claim 1, wherein a perimetric dimension of the upstream portion and/or the downstream portion is at least 10% of the perimetric extent of the elongate device body.

4. (canceled)

5. A pipeline insertion device as claimed in claim 2, wherein a perimetric dimension of the upstream portion and/or the downstream portion is at least 20% of the perimetric extent of the elongate device body.

6. A pipeline insertion device as claimed in claim 1, wherein a perimetric dimension of the upstream portion is greater than or equal to a perimetric extent of the downstream portion.

7. A pipeline insertion device as claimed in claim 1, wherein at least one first fluid-flow-directing element of the plurality of said fluid-flow-directing elements is positioned on a left-hand lateral-facing portion of the elongate device body, and at least one second fluid-flow-directing element of the plurality of said fluid-flow-directing elements is positioned on a right-hand lateral-facing portion of the elongate device body.

8. A pipeline insertion device as claimed in claim 7, wherein the at least one first fluid-flow-directing elements is asymmetrically positioned with respect to the at least one second fluid-flow-directing elements.

9. A pipeline insertion device as claimed in claim 8, wherein the at least one first fluid-flow-directing elements direct fluid in a first at least in part vertical direction, and the at least one second fluid-flow-directing elements direct fluid in a second at least in part vertical direction which is different to the first at least in part vertical direction.

10. A pipeline insertion device as claimed in claim 7, wherein the lateral-facing portions have a perimetric dimension which is at least 10% of the perimetric extent of the elongate device body.

11. (canceled)

12. A pipeline insertion device as claimed in claim 10, wherein the lateral-facing portions have a perimetric dimension which is at least 25% of the perimetric extent of the elongate device body.

13. A pipeline insertion device as claimed in claim 1, wherein a cross-section of the elongate device body is or is substantially: cylindrical; square; hexagonal; or otherwise geometrically uniform or regular.

14. A pipeline insertion device as claimed in claim 1, wherein the upstream portion is at least in part concave; convex; or flat.

15. A pipeline insertion device as claimed in claim 1, further comprising at least one sampling inlet for an upstream sampling tube on the in-use upstream portion for receiving a sample fluid therein, and/or further comprising at least one sampling outlet for a downstream sampling tube on the in-use downstream portion for returning the sampled fluid.

16. (canceled)

17. A pipeline insertion device as claimed in claim 1, further comprising at least one sampling outlet for a downstream sampling tube in the in-use downstream portion for returning the sampled fluid and a return conduit interconnecting the upstream sampling tube and the downstream sampling tube.

18. A pipeline insertion device as claimed in claim 15, further comprising a sample analysis apparatus for analysing the said sample fluid.

19. A probe device as claimed in claim 1, further comprising at least one upstream pitot tube opening on the in-use upstream portion and/or at least one downstream pitot tube opening on the in-use downstream portion.

20. A pipeline insertion device as claimed in claim 15, further comprising at least one upstream pitot tube opening on the in-use upstream portion and/or at least one downstream pitot tube opening on the in-use portion, wherein the at least one upstream pitot tube opening alternates with the at least one sampling inlet in a longitudinal direction of the elongate device body, and/or the at least one downstream pitot tube opening alternates with the at least one sampling outlet in a longitudinal direction of the elongate device body.

21. (canceled)

22. A pipeline insertion device as claimed in claim 21, further comprising a bore wherein bore is a probe-receiving bore for receiving a probe therein.

23. A pipeline insertion device as claimed in claim 22, wherein the probe is a temperature sensor probe.

24. A pipeline insertion device as claimed in claim 1, further comprising a bore, wherein the bore is a sampling bore or an injection bore.

25. (canceled)

26. A combined pitot tube and sampling device for in-line flow rate measurement and sampling of a fluid in a pipeline, the combined pitot tube and sampling device comprising:
an elongate probe body having an outer surface comprising an in-use upstream portion including at least one upstream pitot tube opening for an upstream pitot tube and an in-use downstream portion including at least one downstream pitot tube opening for a downstream pitot tube; and
at least one sampling inlet for an upstream sampling tube on the in-use upstream portion for receiving a sample fluid therein.

27.-47. (canceled)
